(19) United States
(12) Patent Application Publication
(10) Pub. No.: US 2019/0050565 A1
(43) Pub. Date: Feb. 14, 2019

(54) PROTECTIVE METHOD OF AN ELECRONIC DEVICE AGAINST ATTACKS BY FAULT INJECTION

(71) Applicant: IDEMIA IDENTITY & SECURITY FRANCE, Issy Les Moulineaux (FR)

(72) Inventors: Houssem MAGHREBI, Issy Les Moulineaux (FR); Raphael GESLAIN, Issy Les Moulineaux (FR); Cyrille PEPIN, Issy Les Moulineaux (FR); David DAILLE-LEVEFRE, Issy Les Moulineaux (FR)

(21) Appl. No.: 16/058,804

(22) Filed: Aug. 8, 2018

(30) Foreign Application Priority Data
Aug. 9, 2017 (FR) 1757616

(51) Int. Cl. G06F 21/55

(52) U.S. Cl. CPC G06F 21/554; G06F 2221/034

(57) ABSTRACT

The present invention relates to a method for protection of an electronic device (1) against attacks by fault injection, the method comprising steps of
detection of anomalies likely to inject a fault in the electronic device (1) or be caused by a fault injection in the electronic device (1),
incrementation (206) by an anomaly counter (cpt_velo, cpt_tearing) as a function of the detected anomalies,
comparison (208) between the anomaly counter (cpt_velo, cpt_tearing) and a first threshold (seuil_cpt_velo, seuil_cpt_tearing),
performing a protective measure (210) of the electronic device (1) when the number of counted anomalies reaches the predetermined threshold,

the method being characterized in that the anomaly counter (cpt_velo, cpt_tearing) is incremented (206) only in case of detection of:
a number of anomalies greater or equal to a second threshold (seuil_cpt_hist) strictly less than the first threshold (seuil_cpt_velo, seuil_cpt_tearing) over a period during which a predetermined number (N) of predetermined implementations occurred, or
a number of predetermined implementations greater or equal to a second threshold (N) over a period during which a predetermined number of anomalies strictly less than the first threshold occurred (seuil_cpt_velo, seuil_cpt_tearing).

### FIELD OF THE INVENTION

The present invention relates to a method for protection of an electronic device against attacks by fault injection.

### PRIOR ART

As is known, an attack by fault injection consists of disrupting the physical environment of an electronic device which is executing a program so as to modify the value stored by the device of a variable intended to be used by the program. Such disruptions can be produced in different ways: variation in power supply, variation in clock frequency of the device, emission of electromagnetic or laser radiation, etc.

To protect an electronic device against attacks by fault injection, a method has been proposed comprising the following steps:
detection of anomalies likely to inject a fault in the electronic device or be caused by a fault injection in the electronic device,
increment an anomaly counter each time an anomaly is detected,
comparison between the anomaly counter and a threshold,
executing a protective measure of the electronic device when the number of counted anomalies reaches the predetermined threshold.

The anomaly counter is never decremented during the life of the electronic device.

The protective measure taken can be radical sometimes. By way of example, some specifications recommend making the electronic device fully unusable, for example by deleting the complete content of the non-volatile memory of the electronic device.

It happens that some anomalies likely to inject a fault in the electronic device are not caused by an attack initiated by a malicious person, but are simply caused by poor handling of the electronic device by its user, without the latter being malicious. By way of example, the electronic device can be led to execute a particular implementation involving communication of data with another device. For this purpose, the electronic device can be put in electrical contact with this other device. Accidental breaking of the communication between the two devices present by breaking this electrical contact can be caused accidentally and be categorised as an anomaly likely to inject a fault in the electronic device.

When this handling occurs many times, the threshold of anomalies is exceeded and the protective measure is carried out to the detriment of the user of the electronic device, whereas no attack has really been initiated.

### SUMMARY OF THE INVENTION

An object of the invention is to propose a method which protects a device against attacks by fault injection, without poor handling by a user of the electronic device being confused with such attacks.

The method such as defined in claim 1 is therefore proposed.

The method proposed is based on the following observation: temporally grouped anomalies are likelier to be the consequence of attacks than one-off anomalies, widely spaced apart over time.

The use of the second threshold to condition the incrementation of the anomaly counter exploits this observation astutely.

In fact, if relatively many anomalies (above the second threshold) are detected for N predetermined implementations, it can be reasonably supposed that these anomalies are not accidental and are consequently sanctioned by incrementation of the anomaly counter.

But such a sanction is not applied when too few anomalies are detected for N predetermined implementations. As a consequence, taking a protective measure is not implemented or is at least implemented by way of delay when the electronic device occasionally undergoes poor handling.

### DESCRIPTION OF FIGURES

Other characteristics, aims and advantages of the invention will emerge from the following description which is purely illustrative and non-limiting and which must be considered with respect to the appended drawings, in which:

FIG. 1 schematically illustrates an electronic device according to an embodiment of the invention,

FIG. 2 is a flowchart of steps of the method according to the first embodiment of the invention,

FIG. 3 is a flowchart of steps of the method according to the first embodiment of the invention,

### DETAILED DESCRIPTION OF THE INVENTION

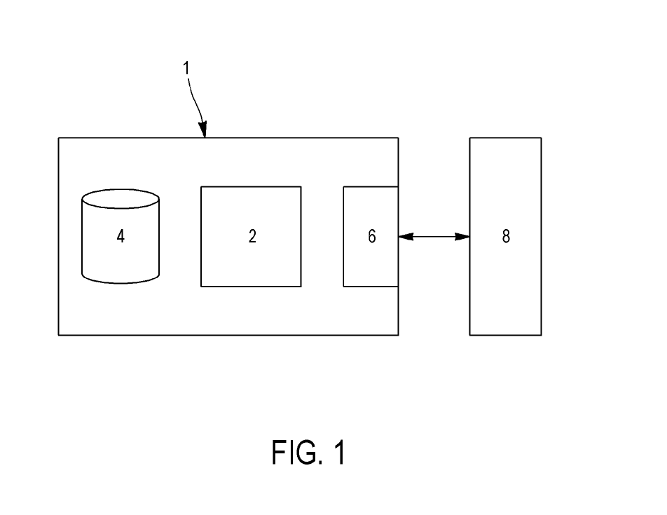

In reference to FIG. 1, an electronic device 1 comprises at least one processor 2, at least one non-volatile memory 4 and a communications interface 6 with another device 8.

The non-volatile memory 4 stores programs and data intended to be handled by the programs. This memory is for example of flash or eeprom type.

The memory 4 stores especially:
at least one target program, whereof the operation is likely to be affected by an attack by fault injection,
a control program whereof the function is to protect the device against such attacks by fault injection.

The processor 2 is configured to execute the control program, especially in parallel with at least one target program.

The communications interface 6 comprises for example at least one electrical contact intended to be put in electrical contact with a contact of the other device 6, such that electrical carrier signals of data can be communicated between the two devices. As a variant or in addition, the communications interface comprises a radio antenna, for example for setting up communication of “near field communication” (NFC) type.

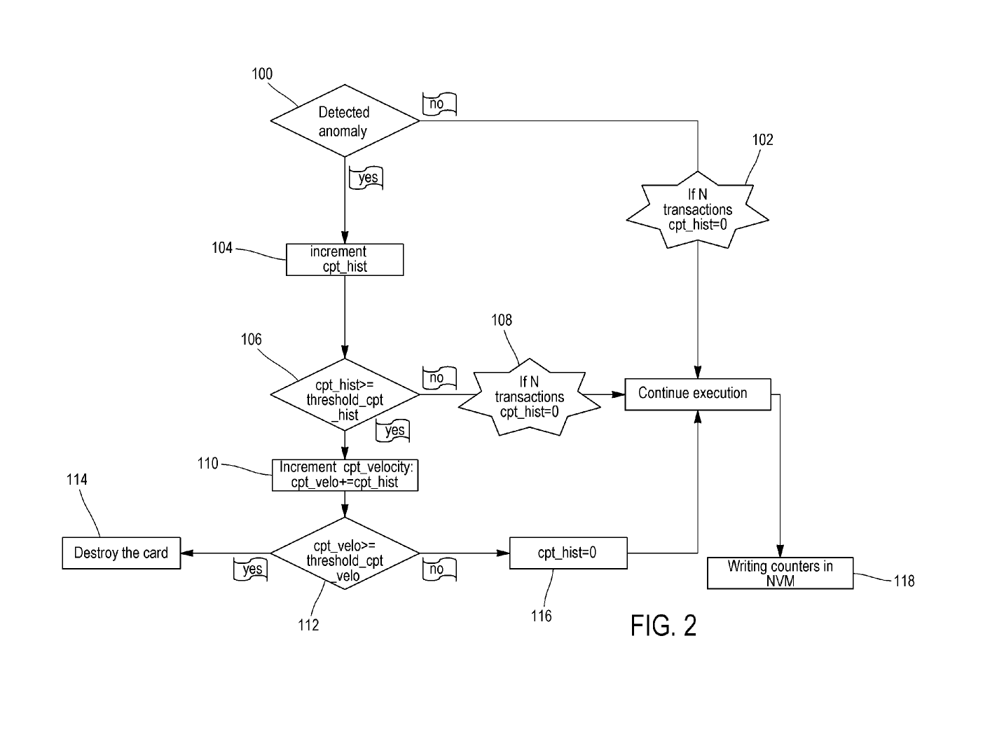

In reference to FIG. 2, the control program is configured to execute a method comprising the following steps, in a first embodiment.

The control program utilises several predetermined data:
a number N of predetermined implementations implemented by at least one of the target programs. This number N can concern one and the same implementation or else several different implementations.
a first threshold called “threshold_cpt_hist”,
a second threshold called “threshold_cpt_velo”.

These data are present in the non-volatile memory prior to first use of the electronic device.

The predetermined implementations can for example be implementations causing incrementation of the velocity counter (“velocity counter ”) described in any one of the following specifications:
“Security Guidelines for Java Card & GlobalPlatform Implementations including Mobile Payments” whereof the version 1.0 has been published in November 2010,
“Security Guidelines for JavaCard Platform Implementation” in its version published in August 2006,
“Security Guidelines for Global Platform Implementations” in its version published in May 2010.

Hereinbelow, the non-limiting example of predetermined implementations will be taken, comprising execution of a bank transaction.

The program also uses three allocated counters in the non-volatile memory.
a counter of predetermined implementations,
a first anomaly counter “ cpt_hist ”
a second anomaly counter “ cpt_velo ”.

These three counters are at zero during initial start-up of the control program.

The control program has means known per se for detecting that one of the predetermined implementations has been executed by the processor 2. With each new execution of one of these implementations, the implementation counter is incremented 1 (or —1—for a negative incrementation).

The control program also conducts the following steps, for example asynchronously with detection of implementations and incrementation of the implementation counter. The control program verifies if an anomaly has been detected (step 100). This verification 100 is for example carried out periodically.

For example, one of the target programs is led to compare a proof datum input by a user with a secret reference datum (typically a PIN code). An anomaly can be considered as detected when the proof datum and the secret reference datum are different (revealing an anomaly by verification of DAP or “Data Authentication Pattern” according to English terminology generally used).

If no anomaly has been detected then the control program compares the implementation counter to the number N. If the implementation counter is greater than equal to N, the first anomaly counter cpt_hist is reset to zero (step 102). If not, the first anomaly counter cpt_hist is not reset to zero.

In response to detection of anomaly 100, the control program increments the first anomaly counter cpt_hist of a first increment, for example equal to 1 (step 104).

The control program then compares the counter cpt_hist to the first threshold seuil_cpt_hist (step 106).

If the first anomaly counter cpt_hist is strictly less than the first threshold seuil_cpt_hist, the second counter cpt_velo is not incremented, but the control program compares the implementation counter to the number N. If the implementation counter is greater than equal to N, the first anomaly counter cpt_hist is reset to zero (step 108). If not, the first anomaly counter cpt_hist is not reset to zero.
If the first anomaly counter cpt_hist is greater than or equal to the first threshold seuil_cpt_hist, the second counter is incremented by a second increment (step 110). The second increment depends on the current value of the first counter cpt_hist.

In particular, the second increment can be equal to the current value of the first counter cpt_hist. This choice has the advantage of complying with the recommendations of GlobalPlatform.
When the second counter cpt_velo has been incremented, the control program compares the second counter cpt_velo au second threshold seuil_cpt_velo (step 112).

If the second anomaly counter cpt_velo is greater than or equal to the second threshold seuil_cpt_velo, the control program performs a protective measure of the electronic device 1 (step 114). In fact in such a case it is assumed that the device 1 has formed the object of an attack by fault injection.

The protective measure comprises for example deletion of the content of the non-volatile memory, in full or in part, so as to make the device unusable.

If the second counter cpt_velo is strictly less than the second threshold seuil_cpt_velo, the first anomaly counter cpt_hist is reset to zero (step 116).

The control program also writes in the non-volatile memory 4 the value of each counter each time this counter is modified (step 118).

Also, each time one of the predetermined implementations is executed once by the processor 2, the control program increments the implementation counter.

During execution of this protective method, it may be noted that the counter cpt_velo is incremented only if a number of anomalies greater than or equal to the threshold seuil_cpt_hist has occurred over a variable period during which N predetermined implementations have occurred.

The counter cpt_velo is never decremented, in keeping with the GlobalPlatform specifications.

It should be noted that the control program can:
count the occurring anomalies and wait until N predetermined implementations have occurred to decide if the counter cpt_velo must be incremented or not (in which case the relevant period, of variable duration, expires when the N^{th} predetermined implementation has just terminated), or else
count the predetermined implementations and wait until seuil_cpt_hist anomalies have occurred to decide if the counter cpt_velo must be incremented or not (in which case the relevant period ends when the predetermined number of anomalies seuil_cpt_hist is reached).

The occurrence of a new anomaly or the execution of one of the predetermined implementations after the term of this period of variable duration marks the start of a new period during which the steps of the method are repeated.

To subvert the protective method implemented, an attacker wanting to make a fault injection will be forced to space his attacks over time, failing which the electronic device 1 will be made unusable on completion of step 114.

Preferably, in terms of a period, the control program modifies the number N of predetermined implementations and/or the value of the threshold seuil_cpt_hist. Once this modification is done, the steps of the method are conducted during a new period. Such modification makes the method less predictable over time. Consequently, it is more difficult for an attacker to comprehend the logic of the protective method being implemented and therefore estimate to what extent his attacks have to be spaced over time.

Even more preferably, the new value of N or the new value of the threshold seuil_cpt_hist is determined randomly. This has the advantage of making the method totally unpredictable.

Also, the number N or the threshold seuil_cpt_hist is preferably:
decreased if the anomaly counter cpt_velo has been incremented during the period,
increased if the anomaly counter cpt_velo has been incremented during the period.

With such modification logic, the method adapts dynamically to the context of use of the electronic device. It becomes more severe when the number of anomalies increases from one period to the other and becomes more lenient in the reverse case.

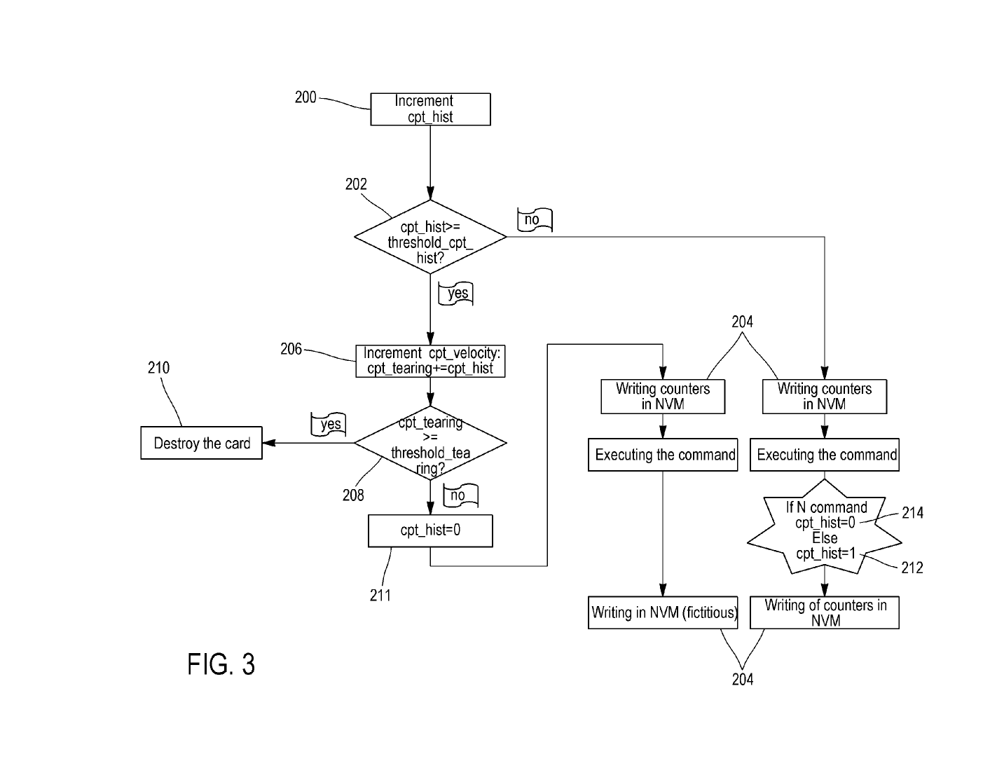

FIG. 3 illustrates the steps of a protective method of the electronic device against attacks by fault injection according to a second embodiment.

One difference with the method according to the first embodiment is that the counter cpt_hist is incremented preventively before an anomaly has been detected, then decremented if it is confirmed that no anomaly has occurred.

This second embodiment is particularly adapted to management of anomalies caused by a break in communication between the electronic device and another device.

The predetermined implementations scrutinized in this second embodiment are typically implementations causing an incrementation of the counter known as “ tearing ” described in any one of the following specifications:
“Security Guidelines for Java Card & GlobalPlatform Implementations including Mobile Payments” whereof the version 1.0 has been published in November 2010,
“Security Guidelines for JavaCard Platform Implementation” in its version published in August 2006,
“Security Guidelines for Global Platform Implementations” in its version published in May 2010.

It is assumed that at least one of the predetermined implementations is an implementation likely to be interrupted (that is, stopped abnormally) by an abnormal communication disruption between the electronic device and another device. This implementation is called “reference implementation” hereinbelow. The reference implementation comprises for example an ADPU command.

In this embodiment, the second counter cpt_velo is replaced by a counter cpt_tearing and the second threshold seuil_cpt_velo is replaced by a threshold seuil_cpt_tearing.

The method according to the second embodiment comprises the following steps.

The control program has means for detecting that execution of the reference implementation by the electronic device has been initiated. Each time the reference implementation is started, the implementation counter is incremented, for example by 1 (step 200).

The control program then compares the implementation counter cpt_hist to the first threshold seuil_cpt_hist (step 202).

If the first anomaly counter cpt_hist is strictly less than the first threshold seuil_cpt_hist, then the second counter cpt_tearing is not incremented. Next, the control program also writes or updates the value of the first counter cpt_hist which has just been incremented in the memory 4 (step 204).

If the first anomaly counter cpt_hist is greater than or equal to the first threshold seuil_cpt_hist, the second counter seuil_tearing is incremented by a second increment (step 206). The second increment depends on the current value of the first counter cpt_hist.

In particular, the second increment can be equal to the current value of the first counter. This choice has the advantage of complying with the GlobalPlatform recommendations.

When the second counter cpt_tearing has been incremented 206, the control program compares the second counter cpt_tearing to the second threshold seuil_cpt_tearing (step 208).

If the second counter cpt_tearing is greater than or equal to the second threshold seuil_cpt_tearing, the control program performs a protective measure of the electronic device (210). In fact in such a case it is assumed that the device is the object of an attack by fault injection. The protective measure comprises for example deletion of the content of the non-volatile memory, in full or in part, so as to make the device unusable.

If the second counter cpt_tearing is strictly less than the second threshold, the second counter is reset to zero (step 211).

The control program writes (or updates) also in the volatile memory the value of each modified counter, after resetting (step 204).

Also, once one of the predetermined implementations terminates, the control program verifies if an anomaly has occurred during execution of the reference implementation.

The program considers that such an anomaly has occurred when the implementation has been interrupted abnormally prior to its completing. When the electronic device 1 communicates with the other device 8 via a wireless communications channel, such an interruption can be caused by a mutual accidental distancing of the two devices 1 and 8 present. When these two devices 1 and 8 communicate via electrical contact, this interruption can be caused by accidental breaking of this electrical contact.

If the control program does not detect an anomaly, it decrements the first counter cpt_hist (step 212). If not (an anomaly has been detected), the control program does not decrement the first counter cpt_hist.

Also, the control program counts the number of executions of predetermined implementations. The control program increments for example the implementation counter by 1 at each termination, normal or abnormal, of a predetermined implementation.

When this implementation counter reaches N, the control program resets the first counter cpt_hist (step 214).

The control program writes and updates the value of each modified counter also in the non-volatile memory 4 (step 204).

It will be clear that there is always writing, that there is or is not an attack, the program using fictitious records for this purpose if needed. In fact, if a counter were incremented only when there is an attack, it would be easy for an attacker to delete or circumvent it.

The counter cpt_tearing is never decremented, in keeping with the GlobalPlatform specifications.

1. A method for protection of an electronic device against attacks by fault injection, the method comprising steps of:
detection of anomalies likely to inject a fault in the electronic device or be caused by a fault injection in the electronic device,
incrementation of an anomaly counter as a function of the detected anomalies,
comparison between the anomaly counter and a first threshold,
performing a protective measure of the electronic device when the number of counted anomalies reaches the predetermined threshold,
wherein the anomaly counter is incremented only in case of detection of:
a number of anomalies greater or equal to a second threshold strictly less than the first threshold over a period during which a predetermined number of predetermined implementations occurred, or
a number of predetermined implementations greater or equal to a second threshold over a period during which a predetermined number of anomalies strictly less than the first threshold occurred.

2. The method according to claim 1, wherein the anomaly counter is incremented by a value equal to the number of anomalies detected over the period.

3. The method according to claim 1, also comprising steps of:
at the end of the period, modification of the predetermined number of predetermined implementations and/or of the second threshold,
after the modification step, repetition of the steps for detection and incrementation of the anomaly counter during a new period.

4. The method according to claim 1, wherein the modification attributes to the predetermined number of predetermined implementations and/or to the second threshold a new value determined randomly.

5. The method according to any one of claims 3 and 4, wherein, during the modification step, the predetermined number of predetermined events and/or the second threshold is:
decreased if the anomaly counter has been incremented during the period,
increased if the anomaly counter has not been incremented during the period.

6. The method according to claim 1, comprising steps of
resetting a second counter at the start of the period,
incrementation of the second counter in response to detection of anomaly occurring during the period,
if the second counter is greater than or equal to the second threshold at the end of the period, incrementation of the anomaly counter with the value of the second counter,
if the second counter is not greater than or equal to the second threshold at the end of the period, no incrementation of the anomaly counter.

7. The method according to claim 1, comprising steps of
resetting a second counter at the start of the period,
incrementation of the second counter each time a predetermined implementation is executed by the electronic device,
decrementation of the second counter selectively each time a predetermined implementation has been executed to term by the electronic device,
if the second counter is greater than or equal to the second threshold at the end of the period, incrementation of the anomaly counter by a value equal to the second counter.

8. The method according to claim 7, wherein the predetermined implementation is an implementation interruptible by abnormal communication disruption between the electronic device and another device.

9. The method according to claim 1, wherein performing a protective measure comprises deletion in a memory of the electronic device of content likely to have been modified by an attack by fault injection.

10. A computer program product comprising program code instructions for carrying out the steps of the method according to claim 1, when this method is executed by at least one processor.
